(19) United States
(12) Patent Application Publication
(10) Pub. No.: US 2003/0166771 A1
(43) Pub. Date: Sep. 4, 2003

(54) Water soluble saline aqueous dispersion of copolymers based on cationic monomers, method for making same and uses thereof

(76) Inventors: Alain Riondel, Forbach (FR); Denis Tembou N'Zudie, Serquigny (FR); Yvon Legrand, Lievin (FR); Didier Vanhoye, Breuil le Vert (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/181,974

(22) PCT Filed: Jan. 19, 2001
(86) PCT No.: PCT/FR01/00181

(51) Int. Cl. C08J 3/00

(52) U.S. Cl. 524/829

(57) ABSTRACT

The invention concerns a water soluble saline dispersion of a copolymer obtained from a composition of water soluble monomers, comprising for 100 mole parts, 0.5 to 65 mole parts of at least a compound (1) and 0.5 to 95 mole parts of at least a monomer (II) and/or diethylaminoethyl (meth)acrylate quaternized with dimethyl sulphate wherein R¹═H or —CH₃; R²═—CH₃; —C₂H₅; —C₃H₇ or —C₄H₉; and compound (I) is optionally quaternized on one of the nitrogen atoms, which is symbolised by the fact that the R³, X⁻ and ⁺ associated with said nitrogen is between square brackets; when compound (I) is quaternized on a single nitrogen, R³ and X⁻ represent the following: (1) R³═—CH₃ or CH₂C₆H₅; and X⁻═Cl⁻ or CH₃OSO⁻; or (2) R³═—(CH₂)ₚCH₃ with p an integer from 3 to 11; and X⁻═Br or I⁻; when compound (I) is quaternized on both nitrogens, both X⁻ can be identical or different and the both R³, can be identical or different, in which case (3) R³═—CH₂—C₆—H₅; and X⁻═Cl⁻; and (4) R³═—(CH₂)ₚCH₃ with p an integer from 3 to 11; and X⁻═Br or I⁻; (5) among the compounds (I) quaternized on both nitrogens and having two different R³, if one of the R³═CH₃, C₂H₅, or C₃H₇; and X⁻═Cl⁻ of CH₃OSO₃⁻; and the other ═—CH₂C₆H₅, the associated X⁻ representing Cl⁻, or represents —(CH₂)ₚCH₃ with p an integer from 3 to 11, The associated X⁻ representing Br or I⁻; R⁸═H or CH₃; A¹=O or NH; B¹═—CH₂—CH₂—or —CH₂—CH₂—CH₂— or —CH₂—CHOH—CH₂—; R⁹ and R¹⁰═—CH₃, —CH₂—CH₃; R¹¹═—(CH₂)ₒ—CH₃(o=3 to 9) or benzyl; X⁻=monovalent ion.

The present invention relates to saline aqueous dispersions of novel water-soluble (co)polymers based on novel cationic monomers, to the preparation of these dispersions and to their applications.

Some of these cationic monomers are novel, their synthesis forming the subject matter of a French patent application filed today on behalf of the Applicant Company and having the title “Novel monomers comprising quaternary amino groups, their process of manufacture and the novel (co)polymers obtained from these novel monomers”. This novel manufacturing process also applies to known monomers, in accordance with a patent application also filed today on behalf of the Applicant Company.

These novel cationic monomers make it possible to obtain water-soluble (co)polymers which are insoluble in an aqueous solution of inorganic salts but which are soluble by simple dilution with water. This property of the (co)polymers is thus taken advantage of in generating, by precipitation, in the course of polymerization in a saline aqueous medium, particles of (co)polymers which are stabilized by a second (co)polymer, which for its part is soluble in the medium and acts as dispersant. The aqueous dispersions of water-soluble (co)polymers thus obtained, which form the subject matter of the present invention, are used in various applications, which applications also form the subject matter of the present invention.

Water-soluble polymers are used for various applications and in particular as flocculants for the treatment of municipal, waste and industrial water, the dehydration of the sludges generated, as thickeners and flow treatment agents. It is well known that aqueous systems of such water-soluble polymers with a high solids content are gelatinous and exhibit very high viscosities, which make them difficult to handle and to store. The problem posed to a person skilled in the art is the production of such aqueous systems but ones having both a high solids content and a low viscosity.

Conventional processes for the synthesis of these polymers comprise solution, reverse suspension and reverse emulsion polymerization. Solution polymerization and reverse suspension polymerization result in products in the powder state which exhibit the disadvantage of generating dust when used, of dissolving with difficulty in water and of not being able to form aqueous solutions of polymers with a high concentration which can be easily handled. In addition to this inconvenient implementation, which is specific to the pulverulent state of the product, these two processes are disadvantageous in terms of production efficiency, first because of the low concentration of monomer used during the polymerization and, secondly, because of the drying and/or milling stage, leading to an increase in the cycle time and an additional energy consumption cost. The reverse emulsion process, which has been known for about two decades, for its part results in a product having a contaminating organic solvent.

To overcome these disadvantages, a novel polymerization technique has been developed which results in aqueous dispersions of water-soluble polymers, the novel feature of which is based on the presentation, that is to say are devoid of contaminating solvent, do not generate dust, are rapidly dissolved in water, have a low viscosity at a high level of polymer and are ready to use. On the other hand, this technology requires the development of polymer dispersants suited to the stability of the polymer dispersed in a saline or nonsaline medium.

Some authors have prepared cationic or nonionic water-soluble polymers by polymerization of water-soluble monomers in the presence of a polymer dispersant of low mass. European patent EP-B-170 394 discloses a dispersion of particles of polymer gel with a size of greater than 20 μm in a solution of poly(sodium acrylic) or poly(diallyldimethylammonium chloride) dispersant. However, this product exhibits the disadvantage of having a high viscosity after a long period of storage, it being possible for the viscosity to be reduced only after shearing or stirring.

European patent applications EP-A-183 466 and EP-A-525 751, United States patents U.S. Pat. Nos. 4,929,655 and 5,006,590, and European patent application EP-A-657 478 provide for the case of precipitating polymerization in a saline medium of water-soluble monomers, the polymer of which precipitates in the form of particles and then is dispersed by means of stirring and is stabilized by polymer dispersants of low mass, which for their part are soluble in a saline medium. Furthermore, these particles are difficult to stabilize because of their large size (2-50 μm).

The problem which is consequently posed to a person skilled in the art comprises:

(1) first, the development of polymer dispersants which are soluble in a saline aqueous medium and which provide for good stability of the particles; and

(2) secondly, the development of water-soluble comonomers which make possible the manufacture of copolymers which are insoluble in an aqueous solution of salts, to make possible, by precipitation, the formation of the particles and, consequently, the “water/water emulsion” polymer dispersion.

As regards the dispersant, two approaches can be envisaged to achieve this objective of stabilization: first, by viscosifying the continuous phase using the associative effects contributed by the dispersant, to prevent the sedimentation of the particles, and, secondly, by promoting effective adsorption of the dispersant at the surface of the particles for better effectiveness as protective colloid, to prevent the coalescence of the particles. In the latter case, the hydrophobic units present in the structure of the dispersant can contribute strongly thereto. These dispersants have to have low masses, to provide for their solubility in a saline aqueous medium, and must have cationic functional groups necessary for the flocculation. Typical dispersants of these polymerizations are poly(diallyldimethylammonium chloride) or the diallyldimethylammonium chloride/(meth)acryloyloxyethyldimethylhexadecylammonium chloride copolymer (cf. European patent application EP-A-657 478). In the latter case, it is disclosed that the associative nature can be provided by the alkyl chains of the (meth)acryloyloxyethyldimethylhexadecylammonium chloride. The synthesis of this dispersant is carried out in an aqueous medium, thus making possible only the use of the second comonomer, which admittedly is less hydrophilic than diallyldimethylammonium chloride, but has to be water-soluble. This point places a considerable limitation on the hydrophobic nature of these dispersing copolymers. It is important to specify that an increase in the hydrophobic nature should make it possible to obtain a dispersion of improved fluidity.

As regards the precipitated polymer to be stabilized, cationic or amphoteric copolymers are obtained by polymerizing a mixture of water-soluble monomers in the presence of dispersant, of water and of salts. As the copolymer is insoluble in a saline aqueous medium, polymer particles are formed by precipitation because of the reduction in the electrostatic repulsions of the polyelectrolyte of high molar mass. The typical monomer mixture for this type of polymerization is composed of (meth)acrylamide, of (meth)acryloxyethyldimethyltrimethylammonium chloride and (meth)acryloxyethyldimethyldimethylbenzylammonium chloride (United States patent U.S. Pat. No. 4,929,655). The latter plays an important role in the precipitation of the cationic polymer formed during synthesis and in the formation of particles. United States patent U.S. Pat. No. 5,587,415 shows that it is possible to dispense with this monomer by substituting it by another equivalent in which the benzyl group is replaced by a sufficiently hydrophobic C₄₋₁₀ alkyl chain. Likewise, United States patent U.S. Pat. No. 5,614,602 shows that the same results can be achieved by partially substituting the (meth)acrylamide by an N-alkylacrylamide or by an N,N-dialkylacrylamide. European patent application EP-A-0 717 056 claims dispersions of amphoteric water-soluble polymers based on cationic monomers, including (meth)acryloxyethyldimethyldimethylbenzylammonium chloride, and anionic monomers (acrylic acid), which dispersions are synthesized in the presence of dispersant.

The patent documents JP-A-61 123 610, EP-A-183 466 and U.S. Pat. No. 5,006,590 disclose a process for the preparation of a saline aqueous dispersion of water-soluble polymer based on at least 5 mol % of acryloxyethyldimethylbenzylammonium chloride (ADAMQUAT BZ). European patent application EP-A-0 525 751 relates to monomers of general formula:

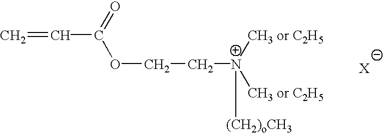

with o an integer from 3 to 9 and X⁻=monovalent anion which can be Cl⁻, Br⁻ or I⁻, including ADAMQUAT C10, the monomer corresponding to o=9, which, used in a proportion of at least 5 mol %, makes it possible to obtain saline aqueous dispersions. United States patent U.S. Pat. No. 5,696,228 provides for the use of diethylaminoethyl acrylate quaternized by dimethyl sulfate:

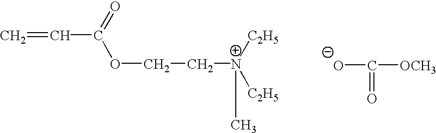

(ADAE DMS)

(between 5 and 55 mol %) in combination with 0 to 35 mol % of ADAMQUAT BZ or of ADAMQUAT MC (acryloxyethyltrimethylammonium chloride) for the preparation of saline aqueous dispersions.

The Applicant Company has now discovered cationic monomers which make possible the preparation of water-soluble polymers which are insoluble in an aqueous solution of inorganic salts but which are soluble by simple dilution with water. It has thus developed a process for the preparation of novel aqueous dispersions of water-soluble polymers, which dispersions are stabilized by a polymer dispersant, these aqueous dispersions meeting the set objectives of exhibiting good fluidity and good stability on storage.

The Applicant Company has shown that copolymers obtained by coupling the abovementioned monomers (of the S-ADAMQUAT 2BZ family, which will be described in more detail below) with the monomers of the ADAMQUAT BZ family (which will also be described in more detail below) make it possible, first, to prepare fluid aqueous dispersions by using a molar level of the monomers of the ADAMQUAT BZ family generally of less than 5% and, secondly, to improve the process and fluidity of the dispersions of polymers having a level of these monomers of the ADAMQUAT BZ family which is greater than 5%.

A first subject matter of the present invention is therefore a saline aqueous dispersion of a water-soluble copolymer obtained from a monomer compositions comprising, per 100 parts by moles:

(1) from 0.10 to 65 parts by moles of at least one compound of formula (I):

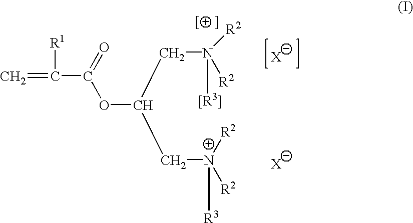

in which:

R¹ represents H or —CH₃;

R² represents —CH₃; —C₂H₅; —C₃H₇ or —C₄H₉; and

the compound (I) is optionally quaternized on one of the nitrogens, which is symbolized by the fact that the R³, X⁻ and ⁺ entities associated with this nitrogen are between square brackets;

when the compound (I) is quaternized on just one nitrogen, R³ and X⁻ have the following meanings:

(1) R³ represents —CH₂—C₆H₅; and X⁻ represents Cl⁻ or CH₃OSO₃—; or

(2) R³ represents —(CH₂)ₚCH₃ with p an integer from 3 to 11; and X⁻ represents Br⁻ or I⁻;

when the compound (I) is quaternized on both nitrogens, the two X⁻ entities can be identical or different and the two R³ entities can be identical or different, in which case:

(3) R³ represents —CH₂—C₆H₅; and X⁻ represents Cl⁻; or

(4) R³ represents —(CH₂)ₚCH₃ with p an integer from 3 to 11; and X⁻ represents Br⁻ or I⁻;

(5) among the compounds (I) quaternized on both nitrogens and having the two R³ entities different, if one of the R³ entities represents —CH₃, —C₂H₅ or —C₃H₇; and X⁻ represents Cl⁻ or CH₃OSO₃—, the other represents —CH₂C₆H₅, the associated x representing Cl⁻, or represents —(CH₂)ₚCH₃ with p an integer from 3 to 11, the associated X⁻ representing Br⁻ or I⁻;

(2) from 0.5 to 95 parts by moles of at least one monomer chosen from:

(2a) those of the formula (II):

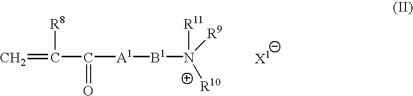

in which:

R⁸ represents H or —CH₃;

A¹ represents —O— or —NH—;

B¹ represents —CH₂—CH₂—, —CH₂—CH₂—CH₂— or —CH₂—CHOH—CH₂—;

R⁹ and R¹⁰ each represent —CH₃ or —CH₂CH₃;

R¹¹ represents —(CH₂)ₒ—CH₃, with o an integer from 3 to 9, or

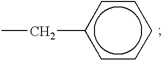

and

—X¹⁻ represents a monovalent ion, such as Cl⁻, SCN⁻, CH₃SO₃⁻ and Br⁻; and

(2b) those of formula (III):

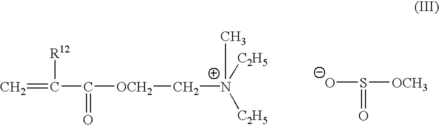

in which:

R¹² represents H or —CH₃;

(3) from 0 to 95 parts by moles of at least one monomer of formula (IV):

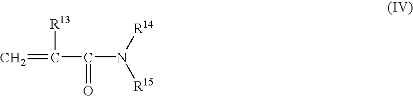

in which:

R¹³ represents H or —CH₃;

R¹⁴ and R¹⁵, which are identical or different, each independently represent H or C₁₋₅ alkyl;

(4) from 0 to 95 parts by moles of at least one monomer of formula (V):

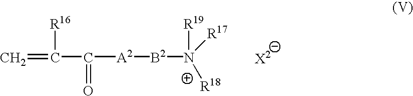

in which:

R¹⁶ represents H or —CH₃;

A² represents —O— or —NH—;

B² represents —CH₂CH₂—, —CH₂CH₂CH₂— or —CH₂CHOHCH₂—;

R¹⁷ and R¹⁸ each independently represent —CH₃ or —CH₂CH₃;

R¹⁹ represents H, —CH₃ or —CH₂CH₃;

X²⁻ represents a monovalent anion, such as Cl⁻, SCN⁻, CH₃SO₃⁻ and Br⁻;

(5) from 0 to 95 parts by moles of at least one monomer of the formula (VI):

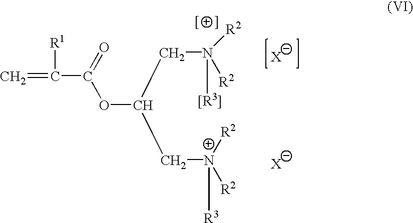

in which:

R¹ represents H or —CH₃;

R² represents —CH₃; —C₂H₅ or —C₃H₇; and

the compound (IV) is optionally quaternized on one of the nitrogens, which is symbolized by the fact that the R³, X⁻ and ⁺ entities associated with this nitrogen are between square brackets;

R³ represents —CH₃, —C₂H₅ or —C₃H₇; and

X⁻ represents Cl⁻ or CH₃OSO₃⁻; and

when the compound (VI) is quaternized on both nitrogens, the two X⁻ entities can be identical or different and the two R³ entities can be identical or different; and

(6) from 0 to 50 parts by moles of at least one anionic monomer chosen from carboxylic acids comprising ethylenic unsaturation, sulfonic acids comprising ethylenic unsaturation, sulfuric acids comprising ethylenic unsaturation and the derivatives of these acids (such as, for example, the salts).

The preferred monomer of formula (I) is the compound of formula (Ia):

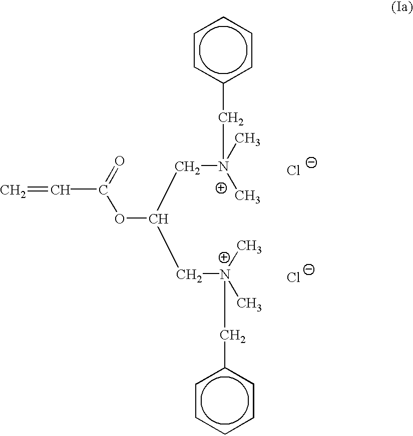

Mention may be made, as examples of monomers (2a), of ADAMQUAT BZ and ADAMQUAT C10, the designations of which were indicated above.

Mention may be made, as examples of monomers (3), of acrylamide, N-methylacrylamide and N,N-dimethylacrylamide.

Mention may be made, as examples of monomers (4), of (meth)acryloxyethyltrimethylammonium halides (chlorides).

Mention may be made, as an example of monomer (5), of the compound of formula (VIa):

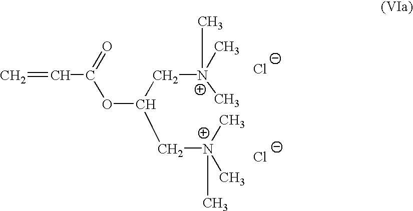

Mention may be made, as examples of monomers (6), of (meth)acrylic acid and the acid 3-sulfopropyl (meth)-acrylate.

In accordance with a preferred embodiment of the dispersions according to the invention, the latter comprise:

(A) from 10 to 50 parts by weight, in particular from 15 to 30 parts by weight, of dispersed copolymer based on the composition of the above-mentioned monomers (1) to (6);

(B) from 0.5 to 25 parts by weight, in particular from 1 to 10 parts by weight, of at least one dispersing (co)polymer; and

(C) from 10 to 45 parts by weight, in particular from 21.5 to 34 parts by weight, of at least one inorganic salt such that the aqueous solution of said salt dissolves said dispersing copolymer without dissolving said dispersed copolymer formed during polymerization,

the remainder being composed of water.

The dispersing (co)polymer or (co)polymers (B) are chosen from cationic, amphoteric or nonionic (co)polymers with a molar mass of less than 600 000, soluble or partially soluble in a saline aqueous medium.

The following may be indicated, by way of example:

poly(diallyldimethylammonium chloride);

poly(acryloxyethyltrimethylammonium chloride);

copolymers based on diallyldimethylammonium chloride or on acryloxyethyltrimethylammonium chloride;

styrene-maleic anhydride copolymers which are imidized and quaternized by an alkyl chloride or benzyl chloride or by an acid;

poly(acrylamidopropylpropyltrimethylammonium chloride);

polyacrylamide;

poly(vinyl alcohol); and

poly(ethylene oxide).

The preferred dispersants are:

cationic polymers based on styrene, on acryloxyethyltrimethylammonium chloride and on polyethoxy methacrylate, with or without a hydrophobic group, the latter being either the triphenylstyryl group or an alkyl chain;

amphoteric polymers based on styrene, on acryloxyethyltrimethylammonium chloride, on methacrylic acid and on polyethoxy methacrylate, with or without a hydrophobic group, the latter being either the triphenylstyryl group or an alkyl chain;

cationic polymers based on styrene, on diallyldimethylammonium chloride and on polyethoxy methacrylate, with or without a hydrophobic group, the latter being either the triphenylstyryl group or an alkyl chain; and

cationic polymers based on styrene, on acryloxyethyltrimethylammonium chloride and on alkyl (meth)acrylate comprising a long C₁₂₋₃₀ chain, the polyethoxy methacrylate with a triphenylstyryl group being represented by the formula (VII):

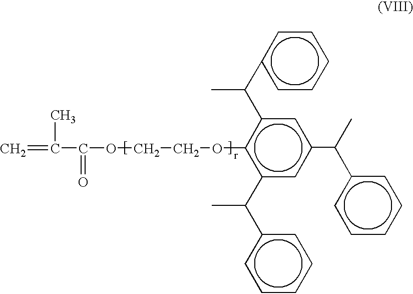

with r an integer from 1 to 60.

The salt or salts (C) are inorganic salts, the aqueous solution of which dissolves the dispersing polymers without dissolving the dispersed polymer formed during the polymerization. Representative salts are ammonium sulfate, sodium sulfate, aluminum sulfate, sodium chloride, sodium dihydrogenphosphate and sodium hydrogenphosphate. These kosmotropic salts can be combined with a chaotropic salt, such as sodium thiocyanate or ammonium thiocyanate.

The present invention also relates to a process for the manufacture of an aqueous dispersion as defined above, characterized in that a radical polymerization in a saline aqueous medium of the monomer or monomers (1) to (6) as defined above is carried out in the presence of at least one polymer dispersant (B) as defined above and of at least one inorganic salt (C) as defined above.

The aqueous dispersion is prepared by using in particular:

from 10 to 50 parts by weight, in particular from 15 to 30 parts by weight, of the composition of the abovementioned water-soluble monomers (1) to (6);

from 0.5 to 25 parts by weight, in particular from 1 to 10 parts by weight, of the polymer dispersant or dispersants (B); and

from 10 to 45 parts by weight, in particular from 21.5 to 34 parts by weight, of the salt or salts (C),

these parts being with respect to 100 parts by weight of the reaction mixture composed of water, the dispersing polymer or polymers (B), the salt or salts (C) and the composition of the monomers (1) to (6).

The salt or salts (C) can be added on two occasions. Thus, during the polymerization, 10 to 30 parts by weight of salt(s), preferably 16.5 to 25 parts by weight, can be added and, in postaddition, 2 to 15 parts by weight of salt(s) can be added. It is also possible to add all the salt or salts during the polymerization.

The polymerization can be initiated by various means, such as free radical generators, for example peroxides, diazo compounds or persulfates, or by irradiation. The preferred form according to the invention is initiation by 2,2′-azobis(N,N′-dimethyleneisobutyramidine) dihydrochloride or 2,2′-azobis(2-aminopropane) hydrochloride. These initiators can be combined with a decomposition accelerator. The polymerization temperature is between −40° C. and 160° C., preferably being from 30 to 95° C. The conversion is greater than 99%.

The present invention also relates to the use of the dispersions of water-soluble copolymers as defined above or prepared by the process as defined above as flocculating agents for the treatment of waste water; dehydrating agents; agents for retaining fibers and fillers in processes for the manufacture of paper; agents facilitating the cleaning of supports, such as textiles; agents for dispersing fillers; inhibiting agents for the transfer of pigments and dyes onto various supports, such as textile; and thickeners.

The examples which will follow, given by way of indication, make possible a better understanding of the invention. In these examples, the parts and percentages indicated are by weight, unless otherwise indicated, and the following abbreviations were used:

ADAME: dimethylaminoethyl acrylate

ADAMQUAT MC: acryloxyethyltrimethylammonium chloride

ADAMQUAT BZ: acryloxyethyldimethylbenzylammonium chloride

S-ADAME: (2-dimethylamino-1-dimethylaminomethyl)-ethyl acrylate:

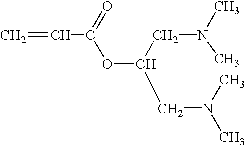

S-ADAMQUAT 2BZ: compound of the abovementioned formula (Ia)

SIPOMER SEM: polyethoxy methacrylate with a triphenylstyryl group, of formula:

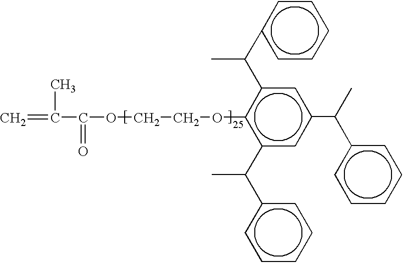

AMA: methacrylic acid

ABAH: 2,2′-azobis(2-aminopropane) hydrochloride

VA-044: 2,2′-azobis(N,N′-dimethyleneisobutyramidine) dihydrochloride

### EXAMPLE 1

### Of Preparation

(a) Synthesis of S-ADAME

The following are charged to a 1 liter glass reactor:

292 g of 1,3-bis(dimethylamino)-2-propanol;

242 g of triethylamine; and

0.373 g of phenothiazine, as stabilizer.

226 g of acrylic anhydride are added to this stirred mixture over 1 hour at ambient temperature while bubbling with air. The temperature increases to reach 50° C. After reacting for an additional 2 hours, the mixture is cooled and 50 ml of water are added. After separating by settling, an upper organic phase of 450 g is obtained and is distilled under reduced pressure to isolate 250 g of the title compound (GC purity ≧99%).

(b) Quaternization of S-ADAME to S-ADAMQUAT 2BZ

44.2 g of the S-ADAME obtained in point (a), stabilized with 1 500 ppm of hydroquinone methyl ether, and 150 g of CHCl₃ are charged to a 250 ml glass reactor. The mixture is brought to 50° C. with stirring and while bubbling with air. 55.9 g of benzyl chloride are added over 1 hour. After reacting for 25 hours, the starting acrylate has disappeared and 33 g of water are added. An upper phase is separated by settling and is freed from the traces of CHCl₃ by stripping with air at 45° C. under reduced pressure (P=1.33×10⁴ Pa) (100 mmHg)). 115.2 g of aqueous solution are thus obtained, which solution comprises 75% of quaternary cationic monomer having the expected structure, determined by ¹³C NMR. This monomer is known as S-ADAMQUAT 2BZ.

### EXAMPLE 2

### Preparation of a Dispersing Copolymer

The following are introduced with stirring into a 1 liter reactor:

703.3 parts of water;

36.83 parts of styrene; and

339.4 parts of an 80% aqueous ADAMQUAT MC solution;

33.6 parts of a commercial aqueous solution composed of SIPOMER SEM, AMA and water, in the proportions of 60% of SIPOMER SEM, 20% of AMA and 20% of water.

The reactor is brought to 70° C. while flushing with nitrogen and with stirring (150 rpm; anchor stirrer). When the temperature of the reaction medium has stabilized at 70° C., 0.2 part of ABAH is subsequently introduced. After reacting for 3 hours at 70° C., the temperature of the reaction medium is brought to 80° C. and 0.2 part of ABAH is introduced. After heating for 2 hours at 80° C., the reaction medium is cooled and a solution comprising 30.3% of water-soluble copolymer is recovered, the copolymer having the molar composition:

styrene/ADAMQUAT MC/SIPOMER SEM/AMA 19.23/76.25/0.67/3.84.

### EXAMPLE 3

### Preparation of an Aqueous Dispersion of Water-Soluble Copolymer, which Dispersion is Stabilized by the Dispersing Copolymer of Example 2

The following are introduced, with stirring, into a 1 liter reactor:

130 parts of water;

120 parts of the aqueous solution comprising 30.3% of water-soluble dispersing copolymer obtained in example 2;

20.43 parts of an aqueous solution comprising 73.5% of S-ADAMQUAT 2BZ;

87.50 parts of 50% acrylamide in water;

60.70 parts of an 80% aqueous ADAMQUAT MC solution;

15.85 parts of an 80% aqueous ADAMQUAT BZ solution; and

100 parts of ammonium sulfate.

The reactor is brought to 53° C. for 30 minutes while flushing with nitrogen and 0.12 part of VA-044, diluted in 12 parts of water, is introduced. The temperature is maintained at 53° C. for 2 hours. 0.048 part of VA-044, diluted in 6 parts of water, is subsequently added and the reaction is allowed to take place for an additional 30 minutes at 53° C. The reactor is heated to a temperature of 60° C. and, after 2 h 30, a postaddition of the following ingredients is carried out:

32 parts of ammonium sulfate;

0.6 part of ammonium thiocyanate; and

6 parts of acetic acid.

After mixing for one hour, the reaction medium is cooled to 30° C. and the reactor is emptied.

A stable dispersion of acrylamide/ADAMQUAT BZ/S-ADAMQUAT 2BZ/ADAMQUAT MC molar 65/4.95/3.5/26.55 copolymer is obtained, which dispersion is stabilized by the copolymer dispersant of example 2 and has a Brookfield viscosity of 1 200 mPa.s (1 200 cP) at 25° C.

### EXAMPLE 4

### Preparation of an Aqueous Dispersion of Water-Soluble Copolymer, which Dispersion is Stabilized by the Dispersing Copolymer of Example 2

The following are introduced, with stirring, into a 1 liter reactor:

138 parts of water;

120 parts of the aqueous solution comprising 30.3% of water-soluble dispersing copolymer obtained in example 2;

17.57 parts of an aqueous solution comprising 73.5% of S-ADAMQUAT 2BZ;

88.38 parts of 50% acrylamide in water;

62.70 parts of an 80% aqueous ADAMQUAT MC solution;

15.85 parts of an 80% aqueous ADAMQUAT BZ solution; and

100 parts of ammonium sulfate.

The reactor is brought to 53° C. for 30 minutes while flushing with nitrogen and 0.12 part of VA-044, diluted in 12 parts of water, is introduced. The temperature is maintained at 53° C. for 2 hours. 0.048 part of VA-044, diluted in 6 parts of water, is subsequently added and the reaction is allowed to take place for an additional 30 minutes at 53° C. The reactor is heated to a temperature of 60° C. and, after 2 h 30, a postaddition of the following ingredients is carried out:

32 parts of ammonium sulfate;

0.6 part of ammonium thiocyanate; and

6 parts of acetic acid.

After mixing for one hour, the reaction medium is cooled to 30° C. and the reactor is emptied.

A stable dispersion of acrylamide/ADAMQUAT BZ/S-ADAMQUAT 2BZ/ADAMQUAT MC molar 65/4.95/3/27 copolymer is obtained, which dispersion is stabilized by the copolymer dispersant of example 2 and has a Brookfield viscosity of 1 350 mPa.s (1 350 cP) at 25° C.

### EXAMPLE 5

### Preparation of an Aqueous Dispersion of Water-Soluble Copolymer, which Dispersion is Stabilized by the Dispersing Copolymer of Example 2

The following are introduced, with stirring, into a 1 liter reactor:

138 parts of water;

120 parts of the aqueous solution comprising 30.3% of water-soluble dispersing copolymer obtained in example 2;

12.04 parts of an aqueous solution comprising 73.5% of S-ADAMQUAT 2BZ;

90.27 parts of 50% acrylamide in water;

66.16 parts of an 80% aqueous ADAMQUAT MC solution;

16.35 parts of an 80% aqueous ADAMQUAT BZ solution; and

100 parts of ammonium sulfate.

The reactor is brought to 53° C. for 30 minutes while flushing with nitrogen and 0.12 part of VA-044, diluted in 5 parts of water, is introduced. The temperature is maintained at 53° C. for 2 hours. 0.048 part of VA-044, diluted in 6 parts of water, is subsequently added and the reaction is allowed to take place for an additional 30 minutes at 53° C. The reactor is heated to a temperature of 60° C. and, after 2 h 30, a postaddition of the following ingredients is subsequently carried out:

32 parts of ammonium sulfate;

0.6 part of ammonium thiocyanate; and

6 parts of acetic acid.

After mixing for one hour, the reaction medium is cooled to 30° C. and the reactor is emptied. A stable dispersion of acrylamide/ADAMQUAT BZ/S-ADAMQUAT 2BZ/ADAMQUAT MC molar 65/4.95/2/27 copolymer is obtained, which dispersion is stabilized by the copolymer dispersant of example 2 and has a Brookfield viscosity of 1 800 mPa.s (1 800 cP) at 25° C.

### EXAMPLE 6 (COMPARATIVE)

### Preparation of an Aqueous Dispersion of Water-Soluble Copolymer Without S-ADAMQUAT 2BZ

The following are introduced, with stirring, into a 1 liter reactor:

138 parts of water;

120 parts of the aqueous solution comprising 30.3% of water-soluble dispersing copolymer obtained in example 2;

96.72 parts of 50% acrylamide in water;

72.30 parts of an 80% aqueous ADAMQUAT MC solution;

17.25 parts of an 80% aqueous ADAMQUAT BZ solution; and

100 parts of ammonium sulfate.

The reactor is brought to 53° C. for 30 minutes while flushing with nitrogen and 0.12 part of VA-044, diluted in 12 parts of water, is introduced. The temperature is maintained at 53° C. for 2 hours. 0.048 part of VA-044, diluted in 6 parts of water, is subsequently added and the reaction is allowed to take place for an additional 30 minutes at 53° C. The. reactor is heated to a temperature of 60° C. and, after 2 h 30, a postaddition of the following ingredients is carried out:

32 parts of ammonium sulfate;

0.6 part of ammonium thiocyanate; and

6 parts of acetic acid.

After mixing for one hour, the reaction medium is cooled to 30° C. and the reactor is emptied.

The product sets solid after polymerizing for 20 minutes and a gel is obtained which is composed of acrylamide/ADAMQUAT BZ/ADAMQUAT MC molar 66/4.95/29.05 copolymer and of the copolymer dispersant of example 2 and which has a high viscosity, unmeasurable by the above device.

For a level of 4.95 mol % of ADAMQUAT BZ in the composition of the monomers to be polymerized, it is therefore impossible to obtain an aqueous polymer dispersion. The copolymer, which does not comprise sufficient cationic units of low hydrophilicity to make possible the precipitation of the polymer, is converted into a highly viscous gel. On the other hand, the incorporation of a low level of S-ADAMQUAT 2BZ (2 to 3.5 mol %) in the composition of the monomer, while retaining the level of ADAMQUAT BZ at 4.95 mol %, renders the novel copolymer less hydrophilic, thus promoting its precipitation and the production of a fluid aqueous dispersion. Furthermore, the fluidity of the dispersion is improved by increasing the level of S-ADAMQUAT 2BZ.

### EXAMPLE 7 (COMPARATIVE)

### Preparation of a Dispersion of Water-Soluble Polymer Without S-ADAMQUAT 2BZ

The following are introduced, with stirring, into a 1 liter reactor:

138 parts of water;

120 parts of the aqueous solution comprising 30.3% of water-soluble dispersing copolymer obtained in example 2;

96.0 parts of 50% acrylamide in water;

62.53 parts of an 80% aqueous ADAMQUAT MC solution;

27.47 parts of an 80% aqueous ADAMQUAT BZ solution; and

100 parts of ammonium sulfate.

The reactor is brought to 53° C. for 30 minutes while flushing with nitrogen and 0.12 part of VA-044, diluted in 12 parts of water, is introduced. The temperature is maintained at 53° C. for 2 hours. 0.048 part of VA-044, diluted in 6 parts of water, is subsequently added and the reaction is allowed to take place for an additional 30 minutes at 53° C. The reactor is heated to a temperature of 60° C. and, after 2 h 30, a postaddition of the following ingredients is carried out:

32 parts of ammonium sulfate;

0.6 part of ammonium thiocyanate; and

6 parts of acetic acid.

After mixing for one hour, the reaction medium is cooled to 30° C. and the reactor is emptied.

The product sets solid after polymerizing for 20 minutes and a gel is obtained which is composed of acrylamide/ADAMQUAT BZ/ADAMQUAT MC molar 66.5/8/26 copolymer and of the copolymer dispersant of example 2 and which has a high viscosity, unmeasurable by the above device.

For a higher level of ADAMQUAT BZ (8 mol %) in the composition of the monomers to be polymerized, it is therefore impossible to obtain an aqueous polymer dispersion. The copolymer, which does not comprise sufficient cationic units of low hydrophilicity to make possible the precipitation of the polymer, is converted into a highly viscous gel.

### EXAMPLE 8

### Preparation of an Aqueous Dispersion of Water-Soluble Polymer Having 8 mol % of ADAMQUAT BZ Coupled with S-ADAMQUAT 2BZ, which Dispersion is Stabilized by the Dispersing Copolymer of Example 2

The following are introduced, with stirring, into a 1 liter reactor:

138 parts of water;

120 parts of the aqueous solution comprising 30.3% of water-soluble dispersing copolymer obtained in example 2;

11.74 parts of an aqueous solution comprising 73.5% of S-ADAMQUAT 2BZ;

88.57 parts of 50% acrylamide in water;

57.86 parts of an 80% aqueous ADAMQUAT MC solution;

25.93 parts of an 80% aqueous ADAMQUAT BZ solution; and

100 parts of ammonium sulfate.

The reactor is brought to 53° C. for 30 minutes while flushing with nitrogen and 0.12 part of VA-044, diluted in 12 parts of water, is introduced. The temperature is maintained at 53° C. for 2 hours. 0.048 part of VA-044, diluted in 6 parts of water, is subsequently added and the reaction is allowed to take place for an additional 30 minutes at 53° C. The reactor is heated to a temperature of 60° C. and, after 2 h 30, a postaddition of the following ingredients is carried out:

32 parts of ammonium sulfate;

0.6 part of ammonium thiocyanate; and

6 parts of acetic acid.

After mixing for one hour, the reaction medium is cooled to 30° C. and the reactor is emptied.

A stable dispersion of acrylamide/ADAMQUAT BZ/S-ADAMQUAT 2BZ/ADAMQUAT MC molar 65/8/2/25 copolymer is obtained, which dispersion is stabilized by the copolymer dispersant of example 2 and has a Brookfield viscosity of 1 050 mPa.s (1 050 cP) at 25° C.

### EXAMPLE 9

### Preparation of an Aqueous Dispersion of Water-Soluble Copolymer Having 8 mol % of ADAMQUAT BZ Coupled with S-ADAMQUAT 2BZ, which Dispersion is Stabilized by the Dispersing Copolymer of Example 2

The following are introduced, with stirring, into a 1 liter reactor:

138 parts of water;

120 parts of the aqueous solution comprising 30.3% of water-soluble dispersing copolymer obtained in example 2;

17.25 parts of an aqueous solution comprising 73.5% of S-ADAMQUAT 2BZ;

86.77 parts of 50% acrylamide in water;

54.41 parts of an 80% aqueous ADAMQUAT MC solution;

25.40 parts of an 80% aqueous ADAMQUAT BZ solution; and

100 parts of ammonium sulfate.

The reactor is brought to 53° C. for 30 minutes while flushing with nitrogen and 0.12 part of VA-044, diluted in 12 parts of water, is introduced. The temperature is maintained at 53° C. for 2 hours. 0.048 part of VA-044, diluted in 6 parts of water, is subsequently added and the reaction is allowed to take place for an additional 30 minutes at 53° C. The reactor is heated to a temperature of 60° C. and, after 2 h 30, a postaddition of the following ingredients is carried out:

32 parts of ammonium sulfate;

0.6 part of ammonium thiocyanate; and

6 parts of acetic acid.

After mixing for one hour, the reaction medium is cooled to 30° C. and the reactor is emptied.

A stable dispersion of acrylamide/ADAMQUAT BZ/S-ADAMQUAT 2BZ/ADAMQUAT MC molar 65/8/3/24 copolymer is obtained, which dispersion is stabilized by the copolymer dispersant of example 2 and has a Brookfield viscosity of 800 mPa.s (800 cP) at 25° C.

For a higher level of ADAMQUAT BZ (8 mol %) in the composition of the monomers to be polymerized, the incorporation of S-ADAMQUAT 2BZ exhibits the advantage, first, of improving the fluidity of the dispersion and, secondly, of preventing a highly viscous product from being obtained during polymerization.

1. A saline aqueous dispersion of a water-soluble copolymer obtained from a monomer compositions comprising, per 100 parts by moles:
(1) from 0.10 to 65 parts by moles of at least one compound of formula (I): 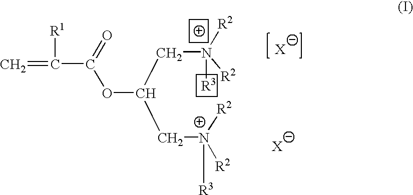
in which:
R¹ represents H or —CH₃;
R² represents —CH₃; —C₂H₅; —C₃H₇ or —C₄H₉; and
the compound (I) is optionally quaternized on one of the nitrogens, which is symbolized by the fact that the R³, X⁻ and ⁺ entities associated with this nitrogen are between square brackets;
when the compound (I) is quaternized on just one nitrogen, R³ and X⁻ have the following meanings:
(1) R³ represents —CH₂C₆H₅; and X⁻ represents Cl⁻ or CH₃OSO₃⁻; or
(2) R³ represents —(CH₂)ₚCH₃ with p an integer from 3 to 11; and X⁻ represents Br⁻ or I⁻;
when the compound (I) is quaternized on both nitrogens, the two X⁻ entities can be identical or different and the two R³ entities can be identical or different, in which case:
(3) R³ represents —CH₂—C₆H₅; and X⁻ represents Cl⁻; or
(4) R³ represents —(CH₂)ₚCH₃ with p an integer from 3 to 11; and X⁻ represents Br⁻ or I⁻;
(5) among the compounds (I) quaternized on both nitrogens and having the two R³ entities different, if one of the R³ entities represents —CH₃, —C₂H₅ or —C₃H₇; and X⁻ represents Cl⁻ or CH₃OSO₃⁻, the other represents —CH₂C₆H₅, the associated X⁻ representing Cl⁻, or represents —(CH₂)ₚCH₃ with p an integer from 3 to 11, the associated X⁻ representing Br⁻ or I⁻;
(2) from 0.5 to 95 parts by moles of at least one monomer chosen from:
(2a) those of the formula (II): 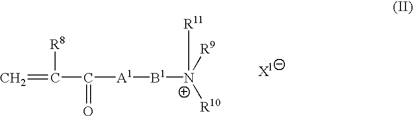
in which:
R⁸ represents H or —CH₃;
A¹ represents —O— or —NH—;
B¹ represents —CH₂—CH₂—, —CH₂—CH₂—CH₂— or —CH₂—CHOH—CH₂—;
R⁹ and R¹⁰ each represent —CH₃ or —CH₂CH₃;
R¹¹ represents —(CH₂)ₒ—CH₃, with o an integer from 3 to 9, or 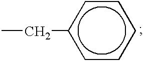
and
X¹⁻ represents a monovalent ion; and
(2b) those of formula (III): 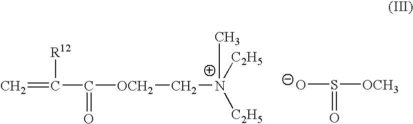
in which:
R¹² represents H or —CH₃;
(3) from 0 to 95 parts by moles of at least one monomer of formula (IV): 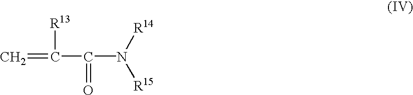
in which:
R represents H or —CH₃;
R¹⁴ and R¹⁵, which are identical or different, each independently represent H or C₁₋₅ alkyl;
(4) from 0 to 95 parts by moles of at least one monomer of formula (V): 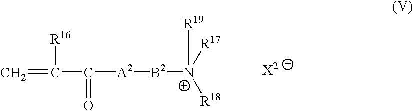
in which:
R¹⁶ represents H or —CH₃;
A² represents —O— or —NH—;
B² represents —CH₂CH₂—, —CH₂CH₂CH₂— or —CH₂CHOHCH₂—;
R¹⁷ and R¹⁸ each independently represent —CH₃ or —CH₂CH₃;
R¹⁹ represents H, —CH₃ or —CH₂CH₃;
X²⁻ represents a monovalent anion;
(5) from 0 to 95 parts by moles of at least one monomer of the formula (VI): 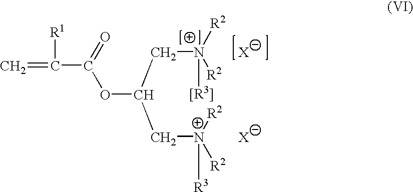
in which:
R¹ represents H or —CH₃;
R² represents —CH₃; —C₂H₅ or —C₃H₇; and
the compound (IV) is optionally quaternized on one of the nitrogens, which is symbolized by the fact that the R³, X⁻ and ⁺ entities associated with this nitrogen are between square brackets;
R³ represents —CH₃, —C₂H₅ or —C₃H₇; and
X⁻ represents Cl⁻ or CH₃OSO₃—; and
when the compound (VI) is quaternized on both nitrogens, the two X⁻ entities can be identical or different and the two R³ entities can be identical or different; and
(6) from 0 to 50 parts by moles of at least one anionic monomer chosen from carboxylic acids comprising ethylenic unsaturation, sulfonic acids comprising ethylenic unsaturation, sulfuric acids comprising ethylenic unsaturation and the derivatives of these acids.

2. The aqueous dispersion as claimed in claim 1, characterized in that the compound (I) is that represented by the formula (Ia):

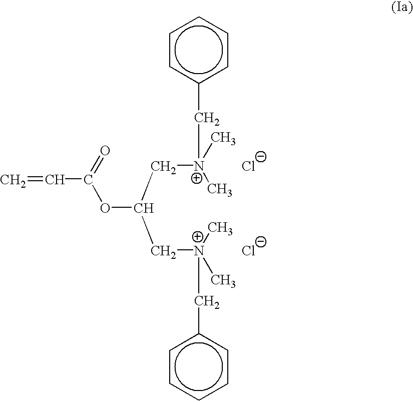

3. The aqueous dispersion as claimed in either of claims 1 and 2, characterized in that it comprises, per 100 parts by weight:
(A) from 10 to 50 parts by weight of dispersed copolymer based on the composition of the monomers (1) to (6) as defined in either of claims 1 and 2;
(B) from 0.5 to 25 parts by weight of at least one dispersing (co)polymer; and
(C) from 10 to 45 parts by weight of at least one inorganic salt such that the aqueous solution of said salt dissolves the dispersing (co)polymer without dissolving the dispersed copolymer formed during polymerization,
the remainder being composed of water.

4. The aqueous dispersion as claimed in claim 3, characterized in that it comprises:
(A) from 15 to 30 parts by weight of the dispersed copolymer;
(B) from 1 to 10 parts by weight of the dispersing (co)polymer or (co)polymers; and
(C) from 21.5 to 34 parts by weight of the inorganic salt or salts, the remainder being composed of water.

5. The dispersion as claimed in either of claims 3 and 4, characterized in that the dispersing (co)polymer or (co)polymers (B) are chosen from cationic, amphoteric or nonionic (co)polymers with a molecular mass of less than 600 000, soluble or partially soluble in a saline aqueous medium.

6. The dispersion as claimed in claim 5, characterized in that the dispersing (co)polymer or (co)polymers (B) are chosen from:
poly(diallyldimethylammonium chloride);
poly(acryloxyethyltrimethylammonium chloride);
copolymers based on diallyldimethylammonium chloride or on acryloxyethyltrimethylammonium chloride;
styrene-maleic anhydride copolymers which are imidized and quaternized by an alkyl chloride or benzyl chloride or by an acid;
poly(acrylamidopropylpropyltrimethylammonium chloride);
polyacrylamide;
poly(vinyl alcohol); and
poly(ethylene oxide).

7. The dispersion as claimed in claim 6, characterized in that the dispersing (co)polymer or (co)polymers are chosen from:
cationic polymers based on styrene, on acryloxyethyltrimethylammonium chloride and on polyethoxy methacrylate, with or without a hydrophobic group, the latter being either the triphenylstyryl group or an alkyl chain;
amphoteric polymers based on styrene, on acryloxyethyltrimethylammonium chloride, on methacrylic acid and on polyethoxy methacrylate, with or without a hydrophobic group, the latter being either the triphenylstyryl group or an alkyl chain;
cationic polymers based on styrene, on diallyldimethylammonium chloride and on polyethoxy methacrylate, with or without a hydrophobic group, the latter being either the triphenylstyryl group or an alkyl chain;
cationic polymers based on styrene, on acryloxyethyltrimethylammonium chloride and on alkyl (meth) acrylate comprising a long C₁₂-C₃₀ chain,
the polyethoxy methacrylate with a triphenylstyryl group being represented by the formula (VTI): 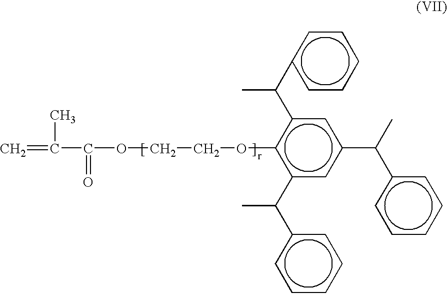
with r an integer from 1 to 60.

8. The dispersion as claimed in one of claims 1 to 7, characterized in that the salt or salts (C) are chosen from ammonium sulfate, sodium sulfate, aluminum sulfate, sodium chloride, sodium dihydrogenphosphate and sodium hydrogenphosphate, it being possible for these kosmotropic salts to be combined with a chaotropic salt, such as sodium thiocyanate or ammonium thiocyanate.

9. A process for the manufacture of the aqueous dispersion as defined in one of claims 1 to 8, characterized in that the radical polymerization in a saline aqueous medium of the monomer or monomers (1) to (6) as defined in either of claims 1 and 2 is carried out in the presence of at least one polymer dispersant (B) as defined in claim 3 and of at least one inorganic salt (C) as defined in claim 3.

10. The process as claimed in claim 10, characterized in that the aqueous dispersion is prepared by using:
from 10 to 50 parts by weight of the composition of the water-soluble monomers (1) to (6);
from 0.5 to 25 parts by weight of the polymer dispersant or dispersants (B); and
from 10 to 45 parts by weight of the salt or salts (C),
these parts being with respect to 100 parts by weight of the reaction mixture composed of water, the dispersing polymer or polymers (B), the salt or salts (C) and the composition of the monomers (1) to (6).

11. The process as claimed in claim 10, characterized in that the aqueous dispersion is prepared by using:
from 15 to 30 parts by weight of the composition of the water-soluble monomers (1) to (6);
from 1 to 10 parts by weight of the polymer dispersant or dispersants (B); and
from 21.5 to 34 parts by weight of the salt or salts (C),
these parts being with respect to 100 parts by weight of the reaction mixture composed of water, the dispersing polymer or polymers (B), the salt or salts (C) and the composition of the monomers (1) to (6).

12. The process as claimed in one of claims 9 to 11, characterized in that it is carried out at a temperature of −40° C. to 160° C.

13. The process as claimed in claim 12, characterized in that it is carried out at a temperature of 30 to 95° C.

14. The use of the dispersion of water-soluble copolymers as defined in one of claims 1 to 8 or prepared by the process as defined in one of claims 9 to 13, as flocculating agent for the treatment of waste water; dehydrating agent; agent for retaining fibers and fillers in processes for the manufacture of paper; agent facilitating the cleaning of supports, such as textiles; agent for dispersing fillers; inhibiting agent for the transfer of pigments and dyes onto various supports, such as textile; and thickener.
